(19) United States
(12) Patent Application Publication
(10) Pub. No.: US 2006/0084744 A1
(43) Pub. Date: Apr. 20, 2006

(54) Silicone rubber composition comprising untreated aluminum hydroxide as filler

(75) Inventors: Arvid Kuhn, Muehldorf (DE); Christine Leitermann, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/245,818

(22) Filed: Oct. 7, 2005

(30) Foreign Application Priority Data
Oct. 14, 2004 (DE) 10 2004 050 129.7

(51) Int. Cl. C08K 3/34

(52) U.S. Cl. 524/492

(57) ABSTRACT

Silicone rubber compositions for high-voltage insulators are prepared from addition- or peroxide-crosslinking silicone rubber compositions which contain untreated aluminum hydroxide and a silica reinforcing filler having a high proportion of Q4 units.

### BACKGROUND OF THE INVENTION

1. Field of the Invention

The invention relates to silicone rubber compositions for high-voltage insulators. More exactly, the invention relates to addition- or peroxide-crosslinking silicone rubber compositions which comprise aluminum hydroxide as a filler, untreated aluminum hydroxide being used.

2. Background Art

Aluminum hydroxide, also known as aluminum trihydrate (ATH), is a stoichiometrically defined, crystalline aluminum hydroxide, which is obtainable from precipitates by adding bases to aluminum salt solutions or from bauxite, or hydrated aluminum oxide, frequently referred to in the industry as hydrated clay, which has the composition Al₂O₃.H₂O or Al₂O₃.3H₂O and may therefore be regarded as a hydrated oxide, and as an amphoteric component of mineral aluminum deposits, such as, for example, bauxite or alumogel.

Silicone rubber compositions which comprise aluminum hydroxide powders are already known. It is also known that such compositions cure by means of a curing agent, optionally at elevated temperatures, to give a silicone rubber. Curing agents may be, for example, a peroxide or the combination of a transition metal-containing hydrosilylation catalyst and an organosiloxane containing methylhydrogensiloxy groups. It is known to those skilled in the art that some properties of crosslinked rubber which are required for use as a high-voltage insulator, for example, arc resistance and creep resistance, considerably improve as a result of the addition of a sufficient amount of aluminum hydroxide powder to silicone rubber compositions. It is furthermore known that the processing properties of the uncrosslinked composition and the mechanical properties of the crosslinked rubber deteriorate with increasing amounts of aluminum hydroxide. When used as a high-voltage insulator, in particular in open air applications, however, the crosslinked rubber must have sufficient mechanical strength, since there is a continuous mechanical load, for example due to wind and weathering influences, as well as due to damage caused by birds.

The prior art describes silicone rubber compositions which comprise aluminum hydroxide whose surface was treated, for example, with a silane, silazane or siloxane with the aim of improving various properties of the composition or of the rubber, such as, for example, processibility and stability of the uncrosslinked composition and dielectric and also mechanical properties of the crosslinked rubber.

Thus, U.S. Pat. No. 3,965,065 B1 states that the use of aluminum hydroxide in curable organopolysiloxane compositions initially improves the arc resistance. However, this resistance deteriorates substantially if the material is exposed to moisture for some time. A process for the preparation of an improved elastomer-forming composition in which a mixture of aluminum hydroxide and a curable organopolysiloxane is heated for at least 30 minutes to above 100° C. with the result that an elastomer having improved electrical properties is obtained is described.

The use of surface-treated aluminum hydroxide was mentioned as early as the 1970s. U.S. Pat. No. 4,217,466 B1 describes insulators whose shields consist of a silicone elastomer which comprises surface-treated aluminum hydroxide as filler. Preferred treatment reagents are, for example, vinylsilanes.

U.S. Pat. No. 5,691,407 B1 claims addition-crosslinking silicone rubber compositions which comprise surface-treated aluminum hydroxide. The reagent for the surface treatment may be a silane or a silazane, a titanium compound or a polysiloxane. The use of surface-treated aluminum hydroxide leads to improved electrical properties of the silicone rubber when used in high-voltage insulators. The use of surface-treated aluminum hydroxide is preferred, but it is also possible to use untreated aluminum hydroxide in combination with hexamethyldisilazane.

European Patent EP 0 787 772 B1 describes curable silicone rubber compositions which comprise surface-treated aluminum hydroxide but have no further reinforcing fillers and nevertheless have good mechanical strength and electrical properties. The curing agent is a peroxide. The good mechanical properties are achieved substantially by treating the aluminum hydroxide powder with a silane or siloxane which has alkenyl groups and alkoxy or hydroxyl groups, such as, for example, vinyltrimethoxysilane or vinyl-containing organosiloxanes having SiOH or Si—OR terminal groups. The aluminum hydroxide powder may have been pretreated with the reagent, or the treatment can be effected in situ during the preparation of the silicone rubber composition. Comparative examples in which untreated aluminum hydroxide is used as a filler indicate substantially poorer tensile strengths and tear propagation resistances. A rubber which comprises 150 parts of aluminum hydroxide powder, based on 100 parts of polydiorganosiloxane, has a tensile strength of 5.1 MPa and a tear propagation resistance of 13 N/mm if the aluminum hydroxide was treated according to the invention, and a tensile strength of only 1.7 MPa and a tear propagation resistance of 8 N/mm with untreated aluminum hydroxide.

European Patent EP 0 808 868 B2 describes curable silicone rubber compositions which comprise aluminum hydroxide powders surface-treated with an organosilane or organosilazane. The silane or silazane may also comprise alkenyl groups, such as, for example, vinyltrimethoxysilane or tetramethyldivinyldisilazane. The curing agent may be, for example, a peroxide or a combination of a hydrosilylation catalyst and a polyorganosiloxane containing Si—H groups. EP 0 808 868 B2 furthermore states that silicone rubber compositions which comprise conventional aluminum hydroxide are not stable because the aluminum hydroxide absorbs water, and the electrical properties thus deteriorate. The treatment of the aluminum hydroxide powder with an organosilane or organosilazane is described as being essential in order to achieve good water resistance and good electrical properties.

European Patent EP 0 801 111 B1 describes a heat-curable silicone rubber composition which comprises polyorganosiloxane, silica powder, aluminum hydroxide powder, benzotriazole, the reaction product of a platinum compound and 3,5-dimethyl-1-hexyn-3-ol and a peroxide. Such compositions, which comprise from 1.0 to 50 parts by weight of aluminum hydroxide, based on 100 parts by weight of polyorganosiloxane, have improved flameproof properties and electrical properties in comparison with compositions which comprise only platinum compounds or platinum compounds in combination with, for example, titanium dioxide.

European Patent EP 0 808 875 B1 also describes silicone rubber compositions having good low-flammability properties, which may comprise aluminum hydroxide and platinum compounds, these compositions being said to have, prior to curing, sufficient flowability to be readily processible. These compositions comprise polyorganosiloxane, pyrogenic silica, surface-treated zinc carbonate, a polyorganosiloxane containing Si—H groups and a platinum catalyst. Aluminum hydroxide and a further platinum compound are optionally added. If aluminum hydroxide is used, it is surface-treated. The surface treatment of the zinc carbonate and of the aluminum hydroxide is decisive for achieving the aim of the invention.

U.S. Pat. No. 5,668,205 B1 claims addition-crosslinking silicone rubber compositions which comprise aluminum hydroxide and additionally a dimethylpolysiloxane having a terminal trimethylsilyl group for improving the electrical properties. Furthermore, peroxidic silicone rubber compositions comprising aluminum hydroxide are claimed, a major part of the organopolysiloxanes carrying trivinyl- or divinylsilyl terminal groups, and optionally a polysiloxane without unsaturated groups. Such compositions can be processed by injection molding and cured to give silicone rubbers which have improved electrical properties, in particular if an insulator produced from the composition is used in an environment with high atmospheric pollution. The aluminum hydroxide may be untreated or surface-treated. Such polymers having di- or trivinyl terminal groups are not conventional starting materials in silicone chemistry. Their preparation is expensive and complicated and their use is therefore undesirable.

U.S. Pat. No. 6,063,487 B1 describes addition- or peroxide-crosslinking silicone rubber compositions which comprise-aluminum hydroxide, the aluminum hydroxide having a content of water-soluble sodium ions of up to 0.01% by weight, a pH of 6.5-8.0 and an electrical conductivity of up to 50 μS/cm, measured as a 30% by weight suspension in water. Insulators produced from these compositions have improved electrical properties and low water absorption. Better results are obtained if the aluminum hydroxide is rendered hydrophobic by surface treatment.

U.S. Pat. No. 5,977,216 B1 states that aluminum hydroxide itself does not have reinforcing properties. However, because very high degrees of filling of aluminum hydroxide in the silicone rubber compositions are required in order to obtain the desired electrical properties, silicone rubbers having low mechanical strength result therefrom. Curable silicone rubber compositions which comprise aluminum hydroxide which is treated with vinylsilazanes, for example tetramethyldivinyldisilazane, or with vinylalkoxysilanes, for example vinyltrimethoxysilane, in such a way that from 1×10⁻⁶ to 2×10⁻⁴ mol of vinyl groups per gram of aluminum hydroxide are present on the surface are described. The aluminum hydroxide modified in this manner with vinyl groups then has reinforcing properties, so that in spite of a high degree of filling, the strength of the rubber does not suffer. The tensile strength of the rubber comprising surface-treated aluminum hydroxide is from 45 to 58 kgf/cm² (corresponding to 4.41-5.69 N/mm²) in the examples according to the invention, and from 18 to 25 kgf/cm² (1.76-2.45 N/mm²) in the examples with untreated aluminum hydroxide.

European Laid-Open Application EP 0 928 008 A2 describes silicone rubber compositions for high-voltage insulators, in which the aluminum hydroxide is surface-treated in situ. In the preparation of the compositions, untreated aluminum hydroxide is used in combination with an organosilane adhesion promoter. Consequently, the surface of the aluminum hydroxide is rendered hydrophobic, with the result that the interaction of the aluminum hydroxide with the polysiloxane is improved and hence also the dispersibility and the reinforcing effect of the aluminum hydroxide.

U.S. Pat. No. 6,106,954 B1 describes addition-crosslinking organopolysiloxane compositions which comprise surface-treated aluminum hydroxide, the treatment reagent being an organosilane or organosilazane (or a partial hydrolysis product of these reagents) which is free of unsaturated groups. Aluminum hydroxide is used for improving the insulating properties in the silicone rubber. Since, however, aluminum hydroxide is hygroscopic per se, the silicone rubber loses the insulating properties in a humid environment. By using aluminum hydroxide which is surface-treated as described above, the silicone rubber retains its insulating properties even under humid conditions.

European Patent EP 1 037 946 B1 describes addition-crosslinking silicone rubber compositions which comprise aluminum hydroxide and, as a further metal oxide, zinc oxide, and optionally titanium dioxide. With this composition, disadvantages of the prior art described in the Application, such as short shelf life and excessively low creep strength, are overcome. The aluminum hydroxide is preferably surface-treated in situ by an organosilazane.

There are a number of advantages in the prior art in connection with the use of surface-treated aluminum hydroxide powder, such as, for example, processibility and stability of the uncrosslinked composition, mechanical and dielectric properties of the crosslinked rubber and lower water absorption. However, a considerable disadvantage of such compositions is that the surface treatment of the aluminum hydroxide powder is an additional complicated and hence expensive operation. The surface treatment of the aluminum hydroxide powder is preferably effected with treatment compositions such as silanes, which are classed as being hazardous to health or toxic or may eliminate toxic substances during the processing. Appropriate safety measures are therefore necessary. Accordingly, it is advantageous if it is possible to prepare a silicone rubber composition comprising untreated aluminum hydroxide which has the same desirable properties as the compositions described in the prior art which comprise surface-treated aluminum hydroxide.

### SUMMARY OF THE INVENTION

It has now been surprisingly discovered that aluminum hydroxide which is not surface-treated can also be used in the case of specific silicone rubber compositions, wherein the compositions in the uncrosslinked state exhibit good shelf life and the crosslinked silicone rubber meets the high requirements of dielectric tests which are necessary for high-voltage insulators. Thus, even with the use of untreated aluminum hydroxide in the crosslinked rubber, elongations at break of at least 100%, tensile strengths of at least 2 N/mm² and tear propagation resistances of at least 10 N/mm are obtained.

### DETAILED DESCRIPTION OF THE PREFERRED EMBODIMENT(S)

The invention relates to silicone rubber compositions for high-voltage insulators, comprising

(A) 100 parts by weight of at least one diorganopolysiloxane having the general formula (1):
Rₐ¹R_{b}²SO_{(4-a-b)/2}

in which

R¹ is an unsubstituted or halogen-substituted monovalent hydrocarbon radical having 1 to 20 carbon atoms which is free of aliphatically unsaturated groups,

R² is an unsubstituted or halogen-substituted monovalent hydrocarbon radical which is aliphatically unsaturated, each molecule on average having at least two such unsaturated groups bonded to silicon atoms, and

a, b, independently of one another, are positive numbers with the proviso that 1≦a<3, 0<b<1 and 1<a+b≦3,

(B) 1-100 parts by weight, based on 100 parts by weight (A), of finely divided silica having a specific surface area, measured by the BET method, of 50-400 m²/g and a Q4 fraction of SiO_{4/2} units, based on the sum of Q4, Q3 and Q2, of at least 80%,

(C) 50-300 parts by weight, based on 100 parts by weight (A), of at least one aluminum hydroxide powder not surface-modified by a pretreatment step and having a specific surface area, measured according to the BET method, of 0.1-20 m²/g and an average particle size of 0.05-20 μm,

(D) a crosslinking agent in an amount which is sufficient to cure the composition, this crosslinking agent being selected from the group consisting of an organic peroxide or hydroperoxide or a mixture of different organic peroxides or hydroperoxides

or

a combination of an organohydrogenpolysiloxane having the general formula (2)
R_{c}³H_{d}SiO_{(4-c-d)/2} (2)
in which
R³ is a substituted or unsubstituted monovalent hydrocarbon radical which is not aliphatically unsaturated, with the proviso that each molecule has on average at least three such hydrogen atoms bonded to silicon atoms, and
c, d, independently of one another, are positive numbers, with the proviso that 1≦c<3, 0<d≦1 and 1<c+d≦3,
and
a transition metal-containing hydrosilylation catalyst, with the proviso that the crosslinked rubber has elongations at break of at least 100%, tensile strengths of at least 2 N/mm² and tear propagation resistances of at least 10 N/mm.

The component (A) of the silicone rubber composition according to the invention is a diorganopolysiloxane or a mixture of diorganopolysiloxanes of the general formula (1):
Rₐ¹R_{b}²SiO_{(4-a-b)/2} (1)

R¹ is a substituted or unsubstituted monovalent hydrocarbon radical which contains no aliphatically unsaturated groups. R² is a substituted or unsubstituted monovalent hydrocarbon radical which is aliphatically unsaturated, each molecule having on average at least two such unsaturated groups bonded to silicon atoms. The indices a and b are positive numbers which fulfill the equations 1≦a<3, 0<b≦1 and 1<a+b≦3.

In particular, R¹ is a monovalent, SiC-bonded, optionally substituted hydrocarbon radical having 1 to 18 carbon atoms which is free of aliphatic carbon-carbon multiple bonds. Examples of radicals R¹ are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals such as the o-, m- and p-tolyl radicals, xylyl radicals and ethylphenyl radicals; and aralkyl radicals such as the benzyl radical and the α- and the β-phenylethyl radicals.

Examples of substituted radicals R¹ are haloalkyl radicals such as the 3,3,3-trifluoro-n-propyl radical, the 2,2,2,2′,2′,2′-hexafluoroisopropyl radical and the heptafluoroisopropyl radical, and haloaryl radicals such as the o-, m- and p-chlorophenyl radicals, and all radicals mentioned above for R which may be substituted by mercapto groups, epoxy-functional groups, carboxyl groups, keto groups, enamine groups, amino groups, aminoethylamino groups, isocyanato groups, aryloxy groups, hydroxyl groups and halogen groups. The radical R¹ is preferably a monovalent hydrocarbon radical having 1 to 6 carbon atoms, the methyl radical being particularly preferred.

R² is in particular a monovalent, SiC-bonded hydrocarbon radical having an aliphatic carbon-carbon multiple bond. Examples of radicals R² are alkenyl radicals such as the vinyl, 5-hexenyl, cyclohexenyl, 1-propenyl, allyl, 3-butenyl and 4-pentenyl radicals, and alkynyl radicals such as the ethynyl, propargyl and 1-propynyl radical. The radical R² is preferably an alkenyl radical, the vinyl radical being particularly preferred.

In a preferred embodiment, R¹ is a methyl group and R² is a vinyl group. The structure of the diorganopolysiloxanes (A) may be linear or branched, a linear structure being preferred. The viscosity of the diorganopolysiloxanes (A) at 25° C. (determined according to DIN 53018) is from 1000 mPa•s to 50,000,000 mPa•s. In a preferred embodiment, the viscosity of the diorganopolysiloxanes (A) is from 500,000 to 40,000,000 mP•s, more preferably from 2,000,000 to 30,000,000 mPa•s, and hence in the range of the polysiloxanes usually used in high temperature vulcanizing (HTV) rubbers.

In another embodiment, the viscosity of the diorganopolysiloxanes (A) at 25° C. (determined according to DIN 53018) is preferably from 1000 mPa•s to 100,000 mPa•s, more preferably from 5000 to 50,000 mPa•s. Polysiloxanes in this viscosity range are usually used for liquid silicone rubbers (LSR).

The diorganopolysiloxanes (A) may be, for example, vinyl-terminated polydimethylsiloxanes, vinyl-terminated polydimethylpolymethylvinylsiloxanes or trimethylsilyl-terminated polydimethylpolymethylvinylsiloxanes. The component (A) may consist of a single diorganopolysiloxane or of mixtures of two or more diorganopolysiloxanes.

Component (B) is finely divided silica. Component (B) is used as a reinforcing filler which imparts sufficient mechanical strength to the crosslinked silicone rubber.

Examples of reinforcing fillers, i.e. fillers having a BET surface area of at least 50 m²/g, are pyrogenically prepared silica, precipitated silica or silicon-aluminum mixed oxides having a BET surface area of more than 50 m²/g. These fillers may have been rendered hydrophobic, for example by treatment with organosilanes, organosilazanes or organosiloxanes or by etherification of hydroxyl groups to alkoxy groups. Pyrogenically prepared silicas having a BET surface area of at least 100 m²/g are preferred.

The materials according to the invention contain reinforcing fillers in amounts of, preferably, from 1 to 100 parts by weight, preferably from 3 to 50 parts by weight, based on 100 parts by weight of the component (A). At an amount of less than one part by weight, the mechanical strength of the crosslinked rubber is insufficient; at more than 100 parts by weight, the rubber becomes brittle.

It is possible to use one type of filler, but it is also possible to use a mixture of at least two filters.

The surface treatment of the silica can be effected with silicon compounds which contain saturated or unsaturated groups or with mixtures of such silicon compounds. With the use of silicon compounds containing unsaturated groups, the treated silica has corresponding unsaturated groups on the surface. Untreated silica can be used in the preparation of silicone rubber compositions in combination with said silicon compounds or hydroxyl-terminated diorganosiloxane oligomers. The diorganosiloxane oligomers may in turn contain unsaturated groups.

Examples of hydroxyl-terminated diorganosiloxane oligomers are dimethylhydroxysiloxy-terminated dimethylsiloxane oligomers, dimethylhydroxysiloxy-terminated dimethylsiloxane/methylvinylsiloxane copolymer oligomers or hydroxyl-terminated methylvinylsiloxane oligomers. In the siloxane oligomers containing unsaturated groups, the proportion of siloxy units carrying such unsaturated groups is preferably from 1 to 50 mol %, more preferably from 4 to 20 mol %. The viscosity of the oligomers is preferably from 5 to 500 mPa•s, more preferably from 15 to 60 mPa•s. In the surface treatment of the silica, the treatment reagents are preferably chosen so that at least a part of the silicon compounds or siloxane oligomers used contain unsaturated groups. A proportion of at least 10% by weight, of treatment reagents carrying unsaturated groups is preferred, more preferably at least 30% by weight. If the surface of the silica is at least partly modified with unsaturated groups, the mechanical properties of the crosslinked silicone rubber compositions improve even when aluminum hydroxide powder untreated according to the invention is used.

The silica may be characterized by ²⁹Si MAS solid-state NMR spectroscopy through its Si—OH content. The SiO_{4/2} units of the silica show different chemical shifts depending on how many OH groups on the silicon atom (silanol groups) are present. In this context, a distinction is made between Q4 (no OH), Q3 (one OH group on the silicon atom) and Q2 (two OH groups on the silicon atom) units in the case of the SiO_{4/2} units. The ratio of the peak intensities of these signals is a measure of the silanol content of the silica. In the case of overlap of the peaks, the ratio can be determined by deconvolution of the signal using the shifts known from the literature. The chemical shift of the Q4 units is about −110 ppm, that of the Q3 units about −100 ppm and that of the Q2 units about −90 ppm, based on the shift of TMS, as described, for example, in C. C. Liu, G. E. Maciel, J. AM. CHEM. SOC. 1996, 118, 5103.

A silica surface-modified by a hydrophobic step, regardless of whether by pretreatment or in situ treatment, has a proportion of Q4 units, based on the sum of Q2, Q3 and Q4 units, of at least 80%. The higher the proportion of Q4 units, the lower is the silanol content and the better the silica has been rendered hydrophobic. The better the silica has been rendered hydrophobic, the better is the strengthening behavior of the uncrosslinked composition on storage. In a preferred embodiment, the proportion of Q4 units is therefore from 90 to 99 mol %.

In the case of an in situ treatment of the silica, the proportion of Q4 units can be determined after the polymeric components have been separated from the filler using a suitable organic solvent.

Component (C) of the composition according to the invention is decisive for imparting to the crosslinked rubber the electrical properties necessary for use as an insulator, such as arc resistance and creep resistance. The component (C) is aluminum hydroxide powder, also known under the name aluminum trihydrate (ATH), and is usually described by the general formula (3) or (4):
Al(OH)₃ (3)
Al₂O₃.3 H₂O (4)

The aluminum hydroxide may also contain mixed oxides, such as hydrated aluminum oxide AlO(OH). Usually, aluminum hydroxide which has been surface-treated, for example with silanes or silazanes, is used in silicone rubber compositions. In the composition according to the invention, on the other hand, aluminum hydroxide which was not surface-treated is used. Such untreated aluminum hydroxide is obtainable, for example, under the trade name Apyral 40 CD (Nabaltec GmbH, Schwandorf, Germany), Martinal OL-107 or Martinal OL-104 (both from Martinswerk GmbH, Bergheim, Germany) or Micral 632 (J. M. Huber Corporation, Edison, N.J., U.S.A.).

The aluminum hydroxide powder used has an average particle size of 0.05-20 μm, preferably 1-15 μm. The specific surface area, measured by the BET method, of the aluminum hydroxide powder is 0.1-20 m²/g, preferably 1-10 m²/g. In the case of average particle sizes above 20 μm or specific surface areas below 0.1 m²/g, the particles are so large that the aluminum hydroxide powder may no longer be homogeneously distributed in the silicone rubber. In the case of average particle sizes below 0.05 μm or specific surface areas above 20 m²/g, the content of aluminum hydroxide may have a greater effect on the mechanical properties of the rubber.

50-300 parts by weight, based on 100 parts by weight of the component (A), of the component (C) are used, with 80-250 parts by weight being preferred, more preferably 90-200 parts by weight. In the case of excessively large proportions of aluminum hydroxide, processibility of the composition and mechanical properties of the crosslinked rubber deteriorate; in the case of excessively low proportions of aluminum hydroxide, only an insufficient improvement of the electrical properties of the rubber is obtained. Component (C) can be used as a single aluminum hydroxide powder, or combinations of different aluminum hydroxide powders may be used, for example having different particle sizes or specific surface areas or having different morphologies.

Component (D) is a crosslinking agent which is added in an amount which is sufficient to cure the composition, optionally at elevated temperature. Crosslinking agents which cure the composition only at elevated temperature are preferred, since the storability of the uncrosslinked composition is improved thereby. Component (D) may be, for example, an organic or inorganic peroxide or a combination of an organohydrogenpolysiloxane and a hydrosilylation catalyst containing at least one transition metal. If the component (D) is a peroxide, it may be selected from the group consisting of the dialkyl peroxides, diaryl peroxides, alkyl aryl peroxides, aralkyl peroxides and hydroperoxides. An individual peroxide or hydroperoxide or a combination of different peroxides or peroxides with hydroperoxides may be used as component (D). The proportion of component (D), if component (D) is a peroxide, is preferably from 0.1 to 80 parts by weight and more preferably from 0.5 to 40 parts by weight, based in each case on 100 parts by weight of (A).

If the crosslinking of the materials according to the invention is effected by means of free radicals, organic peroxides which serve as a source of free radicals are used as crosslinking agents. Examples of organic peroxides are acyl peroxides, such as dibenzoyl peroxide, bis(4-chlorobenzoyl) peroxide, bis(2,4-dichlorobenzoyl) peroxide and bis(4-methylbenzoyl) peroxide; alkyl peroxides and aryl peroxides, such as di-tert-butyl peroxide, 2,5-bis(tert-butylperoxy)-2,5-dimethylhexane, dicumyl peroxide and 1,3-bis(tert-butylperoxyisopropyl)benzene; perketals, such as 1,1-bis(tert-butoxyperoxy)-3,3,5-trimethylcyclohexane; peresters, such as diacetyl peroxydicarbonate, tert-butyl perbenzoate, tert-butyl peroxyisopropylcarbonate, tert-butyl peroxyisononanoate, dicyclohexyl peroxydicarbonate, and 2,5-dimethylhexane 2,5-diperbenzoate. It is possible to use one type of organic peroxide, but it is also possible to use a mixture of at least two different types of organic peroxides.

If the rubber composition is addition-crosslinking, the component (D) consists of a combination of an organohydrogenpolysiloxane and a hydrosilylation catalyst containing at least one transition metal. The organohydrogenpolysiloxane has the general formula (2)
R_{c}³H_{d}SiO_{(4-c-d)/2} (2)
in which R³ is a substituted or unsubstituted monovalent hydrocarbon radical which is not aliphatically unsaturated. Each molecule has on average at least three such hydrogen atoms bonded to silicon atoms. The indices a and b are positive numbers, with the proviso that the equations 1≦c<3, 0<d≦1 and 1<c+d≦3 are satisfied.

Examples of R³ are alkyl radicals such as the methyl, ethyl, n-propyl, isopropyl, 1-n-butyl, 2-n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as cyclopentyl, cyclohexyl, cycloheptyl and methylcyclohexyl radicals; aryl radicals, such as the phenyl, naphthyl, anthryl and phenanthryl radical; alkaryl radicals such as o-, m- and p-tolyl radicals, xylyl radicals and ethylphenyl radicals; and aralkyl radicals such as the benzyl radical and the α- and the β-phenylethyl radicals.

Examples of substituted radicals R³ are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m- and p-chlorophenyl radical, and all radicals mentioned above for R which may be substituted by mercapto groups, epoxy-functional groups, carboxyl groups, keto groups, enamine groups, amino groups, aminoethylamino groups, isocyanato groups, aryloxy groups, hydroxyl groups and halogen groups.

The organohydrogenpolysiloxane of the general formula (2) is preferably added so that the rubber contains an excess of Si—H, based on vinyl groups.

In the process according to the invention, the catalysts which promote the addition of Si-bonded hydrogen at an aliphatic multiple bond include those which promote the addition of Si-bonded hydrogen at an aliphatic multiple bond. The catalysts are preferably a metal from the group consisting of the platinum metals or a compound or a complex from the group consisting of the platinum metals. Examples of such catalysts are metallic and finely divided platinum which may be present on supports such as silica, alumina or active carbon, compounds or complexes of platinum, such as platinum halides, e.g. PtCl₄, H₂PtCl₆.6H₂O, Na₂PtCl₄.4H₂O, platinum-olefin complexes, platinum-alcohol complexes, platinum-alcoholate complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without a content of detectable inorganically bonded halogen, bis(gamma-picoline)platinum dichloride, trimethylenedipyridineplatinum dichloride, dicyclopentadieneplatinum dichloride, dimethylsulfoxylethyleneplatinum(II) dichloride, cyclooctadieneplatinum dichloride, norbornadieneplatinum dichloride, gamma-picolineplatinum dichloride, cyclopentadieneplatinum dichloride and reaction products of platinum tetrachloride with olefin and primary amine or secondary amine or primary and secondary amine, such as, for example, the reaction product of platinum tetrachloride dissolved in 1-octene with sec-butylamine or ammonium-platinum complexes.

The catalyst is used in the process according to the invention preferably in catalytic amounts. Particularly preferred hydrosilylation catalysts are those which are inert at the storage temperature of the uncrosslinked rubber, preferably below 40° C., but catalyze the composition sufficiently rapidly at elevated temperatures.

Examples of such hydrosilylation catalysts are platinum compounds selected from the group consisting of compounds of the formula (5) 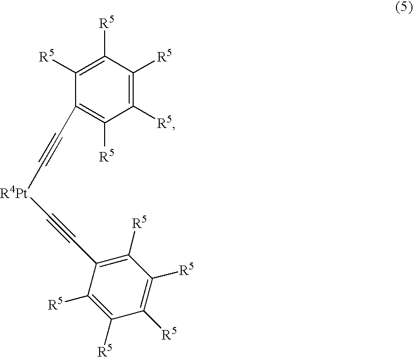
and/or oligomeric or polymeric compounds which are composed of structural units of the general formula (6) 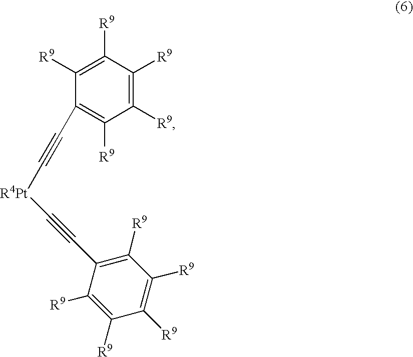
and optionally structural units of the general formula (7)
R¹¹ᵣSiO_{(4-r)/2} (7)
in which
R⁴ is an optionally substituted diene which is linked to platinum by at least one π-bond and is a straight or a branched chain having 4 to 18 carbon atoms or a cyclic ring having 6 to 28 carbon atoms,
R⁵ may be identical or different and is a hydrogen atom, a halogen atom, —SiR⁶₃, —OR⁸ or monovalent, optionally substituted hydrocarbon radicals having 1 to 24 carbon atoms, with the proviso that, in the compounds of the formula (5), at least one radical R⁵ is —SiR⁶₃,
R⁶ may be identical or different and is hydrogen, a halogen atom, —OR⁸ or monovalent, optionally substituted hydrocarbon radicals having 1 to 24 carbon atoms,
R⁸ may be identical or different and is a hydrogen atom, —SiR⁶₃ or a monovalent optionally substituted hydrocarbon radical having 1 to 20 carbon atoms,
R⁹ may be identical or different and is a hydrogen atom, a halogen atom, —SiR⁶₃, —SiR⁶₍₃₋ₜ₎[R¹⁰SiR¹¹ₛO_{(3-s)/2}]ₜ, —OR⁸ or monovalent, optionally substituted hydrocarbon radicals having 1 to 24 carbon atoms, with the proviso that, in formula (6), at least one radical R⁹ is
—SiR⁶₍₃₋ₜ₎[R¹⁰SiR¹¹ₛO_{(3-s)/2}]ₜ,
R¹⁰ may be identical or different and is oxygen or divalent, optionally substituted hydrocarbon radicals having 1 to 24 carbon atoms, which may be bonded to the silicon via an oxygen atom,
R¹¹ may be identical or different and is hydrogen or an organic radical,
r is 0, 1, 2 or 3,
s is 0, 1, 2 or 3, and
t is 1, 2 or 3.

The term organopolysiloxanes is intended to include polymeric, oligomeric and dimeric siloxanes.

If R⁴ is a substituted diene or the radicals R⁵, R⁶, R⁷, R⁸, R⁹ and R¹⁰ are substituted hydrocarbon radicals, halogen atoms, such as F, Cl, Br and I, cyano radicals, —NR⁸₂, hetero atoms, such as O, S, N and P, and groups —OR⁸, in which R⁸ has the abovementioned meaning, are preferred as substituents.

Examples of R⁴ are dienes such as 1,3-butadiene, 1,4-diphenyl-1,3-butadience, 1,3-cyclohexadience, 1,4-cyclohexadiene, 2,4-hexadiene, 1,4-hexadiene, 1,5-hexadiene, 2,5-dimethyl-2,4-hexadience, α- and γ-terpines, (R)-(+)-4-isopropenyl-1-methyl-1-cyclohexene, (S)-(−)-4-isopropenyl-1-methyl-1-cyclohexene, 4-vinyl-1-cyclohexene, 2,5-heptadiene, 1,5-cyclooctadiene, 1-chloro-1,5-cycloooctadiene, 1,5-dimethyl-1,5-cyclooctadiene, 1,6-dimethyl-1,5-cyclooctadiene, 1,5-dichloro-1,5-cyclooctadiene, 1,6-dimethyl-1,5-cyclooctadiene, 1,5-dichloro-1,5-cyclooctadiene, 5,8-dihydro-1,4-dioxocine, η⁴-1,3,5,7-cyclooctatetraene, η₄-1,2,4,7-tetramethyl-1,3,5,7-cyclooctatetraene, 1,8-cyclotetradecadiene, 1,9-cyclohexadecadiene, 1,13-cyclotetracosadien, η⁴-1,5,9-cyclododecatriene, η⁴-1,5,10-trimethyl-1,5,9-cyclododecatriene, η⁴-1,5,9,13-cyclohexadecatetraene, bicyclo[2.2.1]hepta-2,5-diene, 1,3-dodecadiene, methylcyclopentadiene dimer, 4,7-methylene-4,7,8,9-tetrahydroindene, bicyclo[4.2.2]deca-3,9-diene-7,8-dicarboxylate and alkyl bicyclo[4.2.2]deca-3,7,9-triene-7,8-dicarboxylate.

Diene R⁴ is preferably 1,5-cyclooctadiene, 1,5-dimethyl-1,5-cyclooctadiene, 1,6-dimethyl-1,5-cyclooctadiene, 1-chloro-1,5-cyclooctadiene, 1,5-dichloro-1,5-cyclooctadiene, 1,8-cyclotetradecadiene, 1,9-cyclohexadecadiene, 1,13-cyclotetracosadiene, bicyclo[2.2.1]hepta-2,5-diene, 4-vinyl-1-cyclohexene and η⁴-1,3,5,7-cyclooctatetraene, where 1,5-cyclooctadiene, bicyclo[2.2.1]hepta-2,5-diene, 1,5-dimethyl-1,5-cyclooctadiene and 1,6-dimethyl-1,5-cyclooctadiene are particularly preferred.

Examples of R⁵ are alkyl radicals such as the methyl, ethyl, n-propyl, isopropyl, 1-n-butyl, 2-n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical, and isooctyl radicals such as the 2,2,4-trimethylpentyl radical, nonyl radicals such as the n-nonyl radical, decyl radicals such as the n-decyl radical, cycloalkyl radicals such as cyclopropyl, cyclopentyl, cyclohexyl, cycloheptyl radicals and methylcyclohexyl radicals, unsaturated radicals, such as the allyl, 5-hexenyl, 7-octenyl, cyclohexenyl and styryl radicals, aryl radicals such as phenyl radicals, o-, m- and p-tolyl radicals, xylyl radicals and ethylphenyl radicals, aralkyl radicals, such as the benzyl radical and the α- and β-phenylethyl radicals, and radicals of the formula —C(R¹)═CR¹₂. Further examples of R⁵ are OR⁸ radicals, such as hydroxyl, methoxy, ethoxy, isopropoxy, butoxy and phenoxy radicals.

Examples of halogenated radicals R⁵ are are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m- and p-chlorophenyl radicals.

Examples of silyl radicals R⁵ are trimethylsilyl, ethyldimethylsilyl, methoxydimethylsilyl, n-propyldimethylsilyl, isopropyldimethylsilyl, n-butyldimethylsilyl, tert-butyldimethylsilyl, octyldimethylsilyl, vinyldimethylsilyl, phenyldimethylsilyl, diphenylmethylsilyl, hydroxypropyldimethylsilyl, methylvinylphenylsilyl, and methoxypropylsilyl radicals.

Radical R¹ is preferably a hydrogen atom, hydroxyl, or methoxy radical, a hydrocarbon radical having 1 to 8 carbon atoms, or a trimethylsilyl, ethyldimethylsilyl, butyldimethylsilyl, or octyldimethylsilyl radical where a hydrogen atom, the methyl radical and the trimethylsilyl radical are particularly preferred.

Radical R⁶ is a monovalent hydrocarbon radical having 1 to 24 carbon atoms, such as, the examples mentioned in association with the radical R⁵, substituted hydrocarbon radicals, such as hydroxypropyl and chloropropyl radicals, and —OR⁸ radicals such as the hydroxyl, methoxy and ethoxy radicals, where methyl, ethyl, butyl, octyl, methoxy, ethoxy and hydroxypropyl radicals are particularly preferred.

Examples of radical R⁸ are the radicals mentioned for radical R⁵. R⁸ is preferably a hydrogen atom, an alkyl radical or an aryl radical, where a hydrogen atom, and the methyl and ethyl radicals are particularly preferred.

Examples of radical R⁹ are the radicals mentioned for radical R⁵ and 1-trimethylsiloxypropyl-3-dimethylsilyl, 1-ethyldimethylsiloxypropyl-3-dimethylsilyl, 1-methoxydimethylsiloxypropyl-3-dimethylsilyl and pentamethyldisiloxanyl radicals.

R⁹ is preferably a monovalent radical, such as hydrogen, or the methyl, methoxy, trimethylsilyl, octyldimethylsilyl, dimethylmethoxysilyl, 1-trimethylsiloxypropyl-3-dimethylsilyl or hydroxypropyldimethylsilyl radicals, as well as polyvalent radicals such as —C₂H₄—, —Si(Me)₂-O—Si(Me)₂O_{1/2}, —Si(Me)₂-CH₂—CH₂—O—Si(Me)₂O_{1/2}, —Si(Me)₂-O—Si(Me)O_{2/2}, —Si(Me)₂-O—SiO_{3/2}, —Si(Me)₂-CH₂—CH₂—Si(Me)₂O_{1/2} and —Si(Me)₂-CH₂—CH₂—Si(Me)O_{2/2}, where Me is the methyl radical.

Examples of radicals R¹⁰ are an oxygen atom and —CH₂—, —C₂H₄—, —C₃H₆—, —C₄H₈—, —C₆H₁₂—, —C₆H₄—, —CH₂CH(CH₃)-C₆H₄—CH(CH₃)CH₂— and —(CH₂)₃O—, where an oxygen atom, —C₂H₄—, —C₃H₆— and —(CH₂)₃O— are particularly preferred.

Examples of cadical R¹¹ are a hydrogen atom and the examples mentioned for radical R¹ and radical R². R¹¹ is preferably a monovalent hydrocarbon radical having 1 to 12 carbon atoms, where methyl, ethyl, phenyl and vinyl radicals are particularly preferred.

Examples of units of the formula (7) are SiO_{4/2}—, (Me)₃SiO_{1/2}—, Vi(Me)₂SiO_{1/2}—, Ph(Me)₂SiO_{1/2}—, (Me)₂SiO_{2/2}—, Ph(Me)SiO_{2/2}—, Vi(Me)SiO_{2/2}—, H(Me)SiO_{2/2}—, MeSiO_{3/2}—, PhSiO_{3/2}—, ViSiO_{3/2}—, (Me)₂(MeO)SiO_{1/2}— and OH(Me)₂SiO_{1/2}—, where (Me)₃SiO_{1/2}—, Vi(Me)₂SiO_{1/2}—, (Me)₂SiO_{2/2}—, Ph(Me)SiO_{2/2}—, Vi(Me)SiO_{2/2}— and Me₂(MeO)SiO_{1/2}—MeSiO_{3/2}— are preferred and (Me)₃SiO_{1/2}—, Vi(Me)₂SiO_{1/2}, (Me)₂SiO_{2/2}— and Vi(Me)SiO_{2/2}— are particularly preferred, where Me is the methyl radical, Vi is the vinyl radical and Ph is the phenyl radical.

If a hydrosilylation catalyst according to formula (5) to (7) is used as component (D), it is preferably a bis(alkynyl)(1,5-cyclooctadiene)platinum, bis(alkynyl)(bicyclo[2.2.1]hepta-2,5-diene)platinum, bis(alkynyl)(1,5-dimethyl-1,5-cyclooctadiene)platinum or bis(alkynyl)(1,6-dimethyl-1,5-cyclooctadiene)platinum complex.

In addition to the components (A) to (D), further components may optionally be incorporated into the composition.

An inhibitor which regulates the crosslinking rate may be used as an optional component (E). Inhibitors used in the compositions according to the invention as agents which retard the addition of Si-bonded hydrogen at an aliphatic multiple bond at room temperature may be any inhibitor for this purpose. Examples of inhibitors are 1,3-divinyl-1,1,3,3-tetramethyldisiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyn-2,5-diol and 3,5-dimethyl-1-hexyn-3-ol, 3,7-dimethyloct-1-yn-6-en-3-ol, a mixture of diallyl maleate and vinyl acetate, and maleic acid monoesters, and inhibitors such as the compound of the formula HC═C—C(CH₃)(OH)—CH₂—CH₂—CH═C(CH₃)₂, for example obtainable under the trade name “Dehydrolinalool” (BASF AG, Ludwigshafen, Germany).

Preferred components (E) are ethynylcyclohexanol (ECH), dehydrolinalool, 3-methyldodecynol or a diorganosiloxane oligomer which has on average a chain length of up to 50 siloxy units and carries terminal 3-methyl-3-hydroxy-but-1-yn-4-oxy groups. Ethynylcyclohexanol and the diorganosiloxane oligomer carrying terminal 3-methyl-3-hydroxy-but-1-yn-4-oxy groups are particularly preferred.

Additives which produce a further improvement of the electrical properties, of the heat resistance, or of the flammability properties may be used as optional component (F). These additives may be, for example, metal oxides or metal hydroxides, such as antimony trioxide, cerium oxide, magnesium oxide, magnesium hydroxide, titanium dioxide, zinc oxide or zirconium dioxide, or metal or transition metal compounds, such as compounds of palladium or of platinum, optionally in combination with organic compounds which regulate the activity of these compounds in hydrosilylation reactions, or combinations of such additives.

Titanium dioxide is preferred among the metal oxides. In a preferred embodiment, the component (F) consists of the reaction product of a platinum compound or of a platinum complex with an organosilicon compound which has basic nitrogen bonded to the silicon via carbon, or of the combination of such a reaction product with titanium dioxide. Examples of such platinum compounds or platinum complexes are the H₂[PtCl₆].H₂O, platinum-olefin complexes, platinum-alcohol complexes, platinum-alcoholate complexes, platinum-ether complexes and platinum-vinylsiloxane complexes described by way of example in European Patent EP 0 359 252 B1, in particular platinum-1,3-divinyl-1,1,3,3-tetramethyldisiloxane complexes, or the cyclooctadiene complexes of platinum with acetylide ligands, described by way of example in European Patent EP 1 077 226 B1, in particular bis(alkynyl)(1,5-cyclooctadiene)platinum complexes. Platinum-1,3-divinyl-1,1,3,3-tetramethyldisiloxane complexes or cyclooctadiene complexes of platinum with acetylide ligands are preferred.

Examples of the organosilicon compounds which have basic nitrogen bonded to silicon via carbon are N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, 3-aminopropyltrimethoxysilane, 3-aminopropyltriethoxysilane, N-(cyclohexyl)-3-aminopropyltrimethoxysilane, N-(2-aminoethyl)-3-aminopropyltris(trimethylsiloxy)silane, 1,2-bis[N-(2-aminoethyl)-3-aminopropyl]-1,1,2,2-tetramethyldisiloxane, N,N′-bis(3-(trimethoxysilyl)propyl)-1,2-ethanediamine, N,N-bis(3-(trimethoxysilyl)propyl)-1,2-ethanediamine and N,N′-bis(3-(trimethoxysilyl)propyl)urea. 3-Aminopropyltrimethoxysilane, 3-aminopropyltriethoxysilane and N,N′-bis(3-(trimethoxysilyl)propyl)-1,2-ethanediamine are preferred. N-(2-Aminoethyl)-3-aminopropyltrimethoxysilane and N-(2-aminoethyl)-3-aminopropyltriethoxysilane are particularly preferred.

The silicone rubber composition for high-voltage insulators preferably contains at least 15 ppm and not more than 500 ppm of nitrogen. In the case of proportions below 15 ppm of nitrogen, only an insufficient effect is found; in the case of proportions above 500 ppm, the nitrogen content has a disadvantageous effect on the crosslinking of the composition.

Further non-reinforcing fillers and pigments may be present as further optional component (G), provided that they do not adversely affect the desired properties of the composition or of the crosslinked rubber. The further components (G) may be present in proportions of from 0.001 to 100 parts by weight, based on 100 parts by weight of (A). Examples of further components (G) are carbon blacks, graphite, quartz powder, metal salts of carboxylic acids such as calcium stearate, metal oxides or mixed oxides such as iron oxides, cobalt aluminum oxide spinels, cobalt-iron-chromium spinels, aluminum-chromium-cobalt spinels and other spinels, cerium oxide, chromium oxide, titanium dioxide and vanadium oxide, and furthermore processing auxiliaries, such as, for example, nonfunctional polydimethylsiloxanes, hydroxyl-terminated polydimethylsiloxane oils, hydroxyl-terminated polydimethylmethylvinylsiloxane oils, mold release agents and plasticizers.

The composition according to the invention can be prepared by simple mixing of the components in a mixing unit usually used for silicone rubber compositions (kneader, extruder or two-roll mill).

A preparation in which the components (A) (B) and (C) and, if required, optional components (E), (F) and (G) are thoroughly mixed in a kneader, optionally with heating until homogeneity is achieved, is preferred. After the composition has been discharged from the kneader, this precursor is completed with component (D) on a roll mill, it being necessary for the temperature of the composition to remain below the temperature at which precrosslinking of the composition takes place. Instead of being added in the first step, the optional components (E), (F) and (G) can also be added together with component (D) on the roll mill.

In a preferred embodiment, the components (A) and (B) are first mixed together with a surface treatment agent in a suitable mixing unit with heating until homogeneity is achieved. This intermediate is then mixed with the component (C) and, if required, optional components in a second step in a kneader and then completed with component (D) and optional components as above on a roll mill. If the component (D) has a decomposition temperature which is above the temperature reached in the kneader, the component (D) can also be incorporated in the kneader itself.

Owing to their outstanding mechanical and electrical properties, the silicone rubber compositions according to the invention are particularly suitable for the production of high-voltage insulators or flame-retardant cable sheaths. In the organopolysiloxanes employed, each R substituent, i.e. R¹, R², etc., may be identical or different.

### EXAMPLES

Preparation of Base Mixture 1:

In a kneader, 100 parts of a dimethylvinylsiloxy-terminated dimethylsiloxane/methylvinylsiloxane copolymer which contains 99.94 mol % of dimethylsiloxy units and 0.06 mol % of methylvinylsiloxy units and has a degree of polymerization of about 6000 siloxy units are mixed with 31 parts of vinylsilane-treated silica having a surface area, measured according to the BET method, of 300 m²/g, until homogeneity is achieved.

Preparation of Base Mixture 2:

In a kneader, 100 parts of a dimethylvinylsiloxy-terminated dimethylsiloxane/methylvinylsiloxane copolymer which contains 99.94 mol % of dimethylsiloxy units and 0.06 mol % of methylvinylsiloxy units and has a degree of polymerization of about 6000 siloxy units are mixed with 31 parts of silica having a surface area, measured according to the BET method, of 300 m²/g and 7 parts of a dimethylhydroxysiloxy-terminated dimethylsiloxane oligomer having a viscosity of 40 mPa•s until homogeneity is achieved and the mixture is heated to 170° C. for two hours.

Preparation of Base Mixture 3:

In a kneader, 100 parts of a dimethylvinylsiloxy-terminated dimethylsiloxane/methylvinylsiloxane copolymer which contains 99.94 mol % of dimethylsiloxy units and 0.06 mol % of methylvinylsiloxy units and has a degree of polymerization of about 6000 siloxy units are mixed with 31 parts of silica having a surface area, measured according to the BET method, of 300 m²/g, 5 parts of a dimethylhydroxysiloxy-terminated dimethylsiloxane oligomer having a viscosity of 40 mPa•s and 5 parts of a dimethylhydroxysiloxy-terminated dimethylsiloxane/methylvinylsiloxane copolymer oligomer having a viscosity of 40 mPa•s and a methylvinylsiloxy content of 10 mol % until homogeneity is achieved, and the mixture is heated to 170° C. for two hours.

Crosslinking agent 1: dicumyl peroxide.

Crosslinking agent 2: a 50% strength paste of 2,5-dimethyl-2,5-bis(tert-butylperoxy)hexane in silicone oil.

Cross linking agent 3: a trimethylsiloxy-terminated dimethylsiloxy/methylhydrogensiloxy copolymer having an average chain length of 150 siloxy units, a Si—H content of 0.5% by weight and a viscosity of 360 mm2/s at 25° C.

Catalyst 1: a solution of a 1,3-divinyl-1,1,3,3-tetramethyldisiloxaneplatinum complex in a dimethylvinylsiloxy-terminated polydimethylsiloxane, containing 0.025% by weight of platinum.

Catalyst 2: a solution of a 1,5-cyclooctadiene-bis[trimethylsilylphenylethynyl]platinum in a dimethylvinylsiloxy-terminated polydimethylsiloxane, containing 0.025% by weight of platinum.

Additive 1 is prepared as follows: 100 parts of a dimethylvinylsiloxy-terminated dimethylsiloxane/methylvinylsiloxane copolymer which contains 20 mol % of methylvinylsiloxy units and has a viscosity at 25° C. of 50 000 mPa s are homogeneously mixed in a stirring unit with 50 parts of titanium dioxide produced pyrogenically in the gas phase. For this purpose, 25 parts of a mixture containing 1% by weight of Pt (calculated as the element) and comprising a platinum-vinylsiloxane complex (known as Karstedt catalyst; analogous to catalyst 1) are added to a dimethylvinylsiloxy-terminated dimethylpolysiloxane having a viscosity at 25° C. of 1400 mPa•s and mixed until homogeneity is achieved. 4 parts of N-(2-aminoethyl)-3-aminopropyltrimethoxysilane are added to this mixture, heated slowly to 150° C. with vigorous stirring and stirred for two hours at 150° C.

Additive 2 is a 50% strength by weight mixture of a cobalt aluminum oxide spinel obtainable under the trade name Sicopal blau K 6310 (BASF AG, Ludwigshafen, Germany), in base mixture 1.

Additive 3 is a dimethylsiloxane/methylvinylsiloxane copolymer oligomer which has an average chain length of 12 siloxy units and a methylvinylsiloxy content of 8 mol % and carries terminal 3-methyl-3-hydroxybut-1-yn-4-yloxy groups.

### Example 1

In a kneader, 100 parts of base mixture 2 are mixed with 140 parts of untreated aluminum hydroxide (Micral 632; J.M. Huber Corporation, Edison, N.J., U.S.A.) until homogeneity is achieved. 100 parts of this mixture are completed with 1.0 part of crosslinking agent 2 on a roll mill. For the production of test specimens, the composition is pressed for 15 min at 170° C. and then heated for 4 hours at 150° C.

### Example 2

In a kneader, 100 parts of base mixture 2 are mixed with 140 parts of untreated aluminum hydroxide (Micral 632; J.M. Huber Corporation, Edison, N.J., U.S.A.) until homogeneity is achieved. 100 parts of this mixture are completed with 0.035 part of ethynylcyclohexanol as an inhibitor, 3 parts of crosslinking agent 3 and 1 part of catalyst 1 on a roll mill. For the production of test specimens, the composition is pressed for 15 min at 170° C.

### Example 3

In a kneader, 100 parts of base mixture 3 are mixed with 140 parts of untreated aluminum hydroxide (Micral 632; J.M. Huber Corporation, Edison, N.J., U.S.A.) until homogeneity is achieved. 100 parts of this mixture are completed with 1.0 part of crosslinking agent 2 on a roll mill. For the production of test specimens, the composition is pressed for 15 min at 170° C. and then heated for 4 hours at 150° C.

### Example 4

In a kneader, 100 parts of base mixture 2 are mixed with 160 parts of untreated aluminum hydroxide (Martinal OL 104; Martinswerk GmbH, Bergheim, Germany) and 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units until homogeneity is achieved. 100 parts of this mixture are completed with 0.025 part of ethynylcyclohexanol as an inhibitor, 3 parts of crosslinking agent 3 and 1 part of catalyst 1 on a roll mill. For the production of test specimens, the composition is pressed for 15 min at 170° C.

### Example 5

In a kneader, 100 parts of base mixture 3 are mixed with 160 parts of untreated aluminum hydroxide (Martinal OL 104; Martinswerk GmbH, Bergheim, Germany) and 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units until homogeneity is achieved. 100 parts of this mixture are completed with 0.025 part of ethynylcyclohexanol as an inhibitor, 3 parts of crosslinking agent 3 and 1 part of catalyst 1 on a roll mill. For the production of test specimens, the composition is pressed for 15 min at 170° C.

### Example 6

In a kneader, 100 parts of base mixture 3 are mixed with 155 parts of untreated aluminum hydroxide (Martinal OL 104; Martinswerk GmbH, Bergheim, Germany) and 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units until homogeneity is achieved. 100 parts of this mixture are completed with 0.025 part of ethynylcyclohexanol as an inhibitor, 1 part of additive 1, 3 parts of crosslinking agent 3 and 1 part of catalyst 1 on a roll mill. For the production of test specimens, the composition is pressed for 15 min at 170° C.

### Example 7

### (Not According to the Invention)

In a kneader, 100 parts of base mixture 3 are mixed with 160 parts of vinylsilane-treated aluminum hydroxide (Martinal OL 104 S; Martinswerk GmbH, Bergheim, Germany) and 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units until homogeneity is achieved. 100 parts of this mixture are completed with 0.025 part of ethynylcyclohexanol as an inhibitor, 3 parts of crosslinking agent 3 and 1 part of catalyst 1 on a roll mill. For the production of test specimens, the composition is pressed for 15 min at 170° C.

### Example 8

### (Not According to the Invention)

In a kneader, 100 parts of base mixture 2 are mixed with 160 parts of vinylsilane-treated aluminum hydroxide (Hymod M 632 SL; J.M. Huber Corporation, Edison, N.J., U.S.A.) and 1.2 parts of a dimethylhydroxysiloxy-terminated dimethylsiloxane oligomer having a viscosity of 40 mPa•s and 0.8 part of calcium stearate as a processing aid until homogeneity is achieved. 100 parts of this mixture are completed with 0.025 part of ethynylcyclohexanol as an inhibitor, 1 part of additive 1, 3 parts of crosslinking agent 3 and 1 part of catalyst 1 on a roll mill. For the production of test specimens, the composition is pressed for 15 min at 170° C.

### Example 9

In a kneader, 100 parts of base mixture 1 are mixed with 140 parts of untreated aluminum hydroxide (Apyral 40 CD; Nabaltec GmbH, Schwandorf, Germany), 1.5 parts of calcium stearate as a processing aid and 2.2 parts of additive 2 until homogeneity is achieved. 100 parts of this mixture are completed with 0.025 part of ethynylcyclohexanol as an inhibitor, 1 part of additive 1, 3 parts of crosslinking agent 3 and 1 part of catalyst 1. For the production of test specimens, the composition is pressed for 15 min at 170° C.

### Example 10

In a kneader, 100 parts of base mixture 1 are mixed with 140 parts of untreated aluminum hydroxide (Micral 632; J.M. Huber Corporation, Edison, N.J., U.S.A.) and 1.5 parts of calcium stearate as a processing aid until homogeneity is achieved. 100 parts of this mixture are completed with 1.0 part of crosslinking agent 2 and 1.0 part of additive 1 on a roll mill. For the production of test specimens, the composition is pressed for 15 min at 170° C. and then heated for 4 hours at 150° C.

### Example 11

In a kneader, 100 parts of base mixture 1 are mixed with 160 parts of untreated aluminum hydroxide (Apyral 40 CD; Nabaltec GmbH, Schwandorf, Germany) and 1.0 part of titanium dioxide until homogeneity is achieved. 100 parts of this mixture are completed with 1.0 part of crosslinking agent 2 and 1.5 parts of additive 2 on a roll mill. For the production of test specimens, the composition is pressed for 15 min at 170° C. and then heated for 4 hours at 150° C.

### Example 12

In a kneader, 100 parts of base mixture 3 are mixed with 155 parts of untreated aluminum hydroxide (Martinal OL 104; Martinswerk GmbH, Bergheim, Germany) and 0.5 part of a dimethylhydroxysiloxy-terminated dimethylsiloxane/methylvinylsiloxane copolymer oligomer having a viscosity of 40 mPa•s and a methylvinylsiloxy content of 10 mol % and 0.8 part of calcium stearate as a processing aid until homogeneity is achieved. 100 parts of this mixture are completed with 1.0 part of crosslinking agent 2 and 1.0 part of additive 1 on a roll mill. For the production of test specimens, the composition is pressed for 15 min at 170° C. and then heated for 4 hours at 150° C.

### Example 13

In a kneader, 100 parts of base mixture 3 are mixed with 155 parts of untreated aluminum hydroxide (Martinal OL 104; Martinswerk GmbH, Bergheim, Germany), 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units, 0.5 part of a dimethylhydroxysiloxy-terminated dimethylsiloxane/methylvinylsiloxane copolymer oligomer having a viscosity of 40 mPa•s and a methylvinylsiloxy content of 10 mol % and 0.8 part of calcium stearate as a processing aid until homogeneity is achieved. 100 parts of this mixture are completed with 0.025 part of ethynylcyclohexanol as an inhibitor, 1 part of additive 1, 3 parts of crosslinking agent 3 and 1 part of catalyst 2 on a roll mill. For the production of test specimens, the composition is pressed for 15 min at 170° C.

### Example 14

In a kneader, 100 parts of base mixture 3 are mixed with 155 parts of untreated aluminum hydroxide (Martinal OL 104; Martinswerk GmbH, Bergheim, Germany), 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units, and 0.8 part of calcium stearate as a processing aid until homogeneity is achieved. 100 parts of this mixture are completed with 1 part of additive 1, 2 parts of additive 3, 3 parts of crosslinking agent 3 and 1 part of catalyst 2 on a roll mill. For the production of test specimens, the composition is pressed for 15 min at 170° C.

### Example 15

### (Not According to the Invention)

In a kneader, 100 parts of base mixture 3 are mixed with 160 parts of vinylsilane-treated aluminum hydroxide (Martinal OL 104 S; Martinswerk GmbH, Bergheim, Germany), 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units, 0.5 part of a dimethylhydroxysiloxy-terminated dimethylsiloxane/methylvinylsiloxane copolymer oligomer having a viscosity of 40 mPa•s and a methylvinylsiloxy content of 10 mol % and 0.8 part of calcium stearate as a processing aid until homogeneity is achieved. 100 parts of this mixture are completed with 0.025 part of ethynylcyclohexanol as an inhibitor, 1 part of additive 1, 3 parts of crosslinking agent 3 and 1 part of catalyst 2 on a roll mill. For the production of test specimens, the composition is pressed for 15 min at 170° C.

### Example 16

### (Not According to the Invention)

In a kneader, 100 parts of base mixture 3 are mixed with 140 parts of vinylsilane-treated aluminum hydroxide (Martinal OL 104 S; Martinswerk GmbH, Bergheim, Germany), 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units, 0.5 part of a dimethylhydroxysiloxy-terminated dimethylsiloxane/methylvinylsiloxane copolymer oligomer having a viscosity of 40 mPa•s and a methylvinylsiloxy content of 10 mol % and 0.8 part of calcium stearate as a processing aid until homogeneity is achieved. 100 parts of this mixture are completed with 1.0 part of crosslinking agent 2 and 1.0 part of additive 1 on a roll mill. For the production of test specimens, the composition is pressed for 15 min at 170° C. and then heated for 4 hours at 150° C.

### Example 17

### (Not According to the Invention)

In a kneader, 100 parts of base mixture 3 are mixed with 160 parts of vinylsilane-treated aluminum hydroxide (Martinal OL 104 S; Martinswerk GmbH, Bergheim, Germany), 20 parts of a dimethylvinylsiloxy-terminated dimethylsiloxane/methylvinylsiloxane copolymer which contains 99.55 mol % of dimethylsiloxy units and 0.45 mol % of methylvinylsiloxy units and has a degree of polymerization of about 5500 siloxy units, 0.5 part of a dimethylhydroxysiloxy-terminated dimethylsiloxane/methylvinylsiloxane copolymer oligomer having a viscosity of 40 mPa•s and a methylvinylsiloxy content of 10 mol % and 0.8 part of calcium stearate as a processing aid until homogeneity is achieved. 100 parts of this mixture are completed with 1.0 part of crosslinking agent 2 on a roll mill. For the production of test specimens, the composition is pressed for 15 min at 170° C. and then heated for 4 hours at 150° C.

The Shore hardnesses were measured according to DIN 53505-A on 6 mm thick test specimens. The tensile strengths and elongations at break were measured according to DIN 53504 on 2 mm thick S1 dumbbells. The tear propagation resistances were measured according to ASTM D 624 B on 2 mm thick test specimens.

The precure temperatures were measured non-isothermally according to DIN 53529-A3. The T₅₀ values were measured isothermally according to DIN 53529-A3. The results of these measurements are summarized in table 1.

TABLE 1

| | | Tensile | | |
|---|---|---|---|---|
| | Hardness | Strength | Elongation at | Tear propagation |
| Example | [Shore A] | [N/mm²] | break [%] | strength [N/mm] |
| 1 | 67 | 2.0 | 387 | 10.1 |
| 2 | 76 | 3.7 | 181 | 14.9 |
| 3 | 69 | 2.4 | 361 | 11.5 |
| 4 | 78 | 3.9 | 161 | 16.4 |
| 5 | 79 | 4.4 | 169 | 17.1 |
| 6 | 77 | 4.3 | 175 | 16.9 |
| 7 | 74 | 3.9 | 191 | 15.2 |
| (Comp) | | | | |
| 8 | 67 | 2.5 | 528 | 10.8 |
| (Comp) | | | | |
| 9 | 68 | 2.9 | 165 | 15.4 |
| 10 | 71 | 2.2 | 384 | 11.2 |
| 11 | 74 | 2.8 | 371 | 10.3 |
| 12 | 79 | 3.1 | 505 | 14.9 |
| 13 | 75 | 3.9 | 160 | 15.1 |
| 14 | 78 | 4.4 | 181 | 16.3 |
| 15 | 72 | 4.1 | 201 | 15.4 |
| (Comp) | | | | |
| 16 | 70 | 2.9 | 395 | 11.9 |
| (Comp) | | | | |
| 17 | 74 | 2.4 | 370 | 9.5 |
| (Comp) | | | | |

The dielectric strength was tested according to: DIN IEC 243-2. The volume resistivity was tested according to DIN IEC 93. The high-voltage arc resistance was tested according to DIN VDE 0441 Part 1. The high-voltage creep resistance was tested according to DIN IEC 587 (VDE 0303 Part 10). The results relating to these are shown in table 2.

TABLE 2

| | Dielectric | Volume | High-voltage | High-voltage |
|---|---|---|---|---|
| | strength | Resistivity | arc resistance | creep |
| Example | [kV/mm] | [Ω · cm] | [s] | resistance |
| 7 | 21 | 1.19 · 10¹⁵ | 316 | 1 A 4.5 |
| (Comp) | | | | |
| 16 | 19 | 8.95 · 10¹⁴ | 312 | 1 A 4.5 |
| (Comp) | | | | |
| 17 | 22 | 5.77 · 10¹⁴ | 371 | 1 A 4.5 |
| (Comp) | | | | |
| 9 | 22 | 1.27 · 10¹⁵ | 325 | 1 A 4.5 |
| 11 | 22 | 7.83 · 10¹⁴ | 343 | 1 A 4.5 |

The electrical testing after the boiling was effected up to storage for 100 hours in demineralized water with addition of 0.1% of NaCl with a sample thickness of 3 mm. The test results are summarized in table 3.

TABLE 3

| | Dielectric | | | | | |
|---|---|---|---|---|---|---|
| | strength [kV/mm] | | Dielectric constant ε | | Loss factor tan δ | |
| | before | after | before | after | before | after |
| Example | boiling | boiling | boiling | boiling | boiling | boiling |
| 7 | 13.3 | 12.4 | 3.6 | 4.3 | 0.006 | 0.085 |
| (Comp) | | | | | | |
| 17 | 12.9 | 13.2 | 3.7 | 4.4 | 0.007 | 0.059 |
| (Comp) | | | | | | |
| 9 | 13.2 | 12.5 | 3.7 | 4.7 | 0.006 | 0.089 |
| 11 | 12.5 | 11.8 | 3.7 | 4.8 | 0.006 | 0.073 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A silicone rubber composition for high-voltage insulators, comprising
(A) 100 parts by weight of at least one diorganopolysiloxane having the formula (1):
Rₐ¹R_{b}²SiO_{(4-a-b)/2}
in which
R¹ is an unsubstituted or halogen-substituted monovalent hydrocarbon radical having 1 to 20 carbon atoms which is free of aliphatically unsaturated groups,
R² is an unsubstituted or halogen-substituted monovalent hydrocarbon radical which is aliphatically unsaturated, each molecule on average having at least two such unsaturated groups bonded to silicon atoms, and
a, b, independently of one another, are positive numbers
with the proviso that 1≦a<3, 0<b≦1 and 1<a+b≦3,
(B) 1-100 parts by weight, based on 100 parts by weight of (A), of finely divided silica having a specific surface area, measured by the BET method, of 50-400 m²/g and a Q4 fraction of SiO_{4/2} units, based on the sum of Q4, Q3 and Q2, of at least 80%,
(C) 50-300 parts by weight, based on 100 parts by weight (A), of at least one aluminum hydroxide powder not surface-modified by a pretreatment step and having a specific surface area, measured according to the BET method, of 0.1-20 m²/g and an average particle size of 0.05-20 μm,
(D) a crosslinking agent in an amount which is sufficient to cure the composition, this crosslinking agent being
an organic peroxide or hydroperoxide or a mixture of different organic peroxides or hydroperoxides,
or
a combination of an organohydrogenpolysiloxane having the general formula (2)
R_{c}³H_{d}SiO_{(4-c-d)/2} (2)
in which
R³ is a substituted or unsubstituted monovalent hydrocarbon radical which is not aliphatically unsaturated, with the proviso that each molecule has on average at least three such hydrogen atoms bonded to silicon atoms, and
c, d, independently of one another, are positive numbers,
with the proviso that 1≦c<3, 0<d≦1 and 1<c+d≦3,
and
a hydrosilylation catalyst containing at least one transition metal,
with the proviso that the crosslinked rubber has an elongation at break of at least 100%, a tensile strength of at least 2 N/mm², and a tear propagation resistance of at least 10 N/mm.

2. The silicone rubber composition of claim 1, wherein (D) is an organic peroxide or hydroperoxide or a mixture of different organic peroxides or hydroperoxides.

3. The silicone rubber compositions of claim 1, wherein (D) is combination of an organohydrogenpolysiloxane having the general formula (2):
R_{c}³H_{d}SiO_{(4-c-d)/2} (2),
in which
R³ is a substituted or unsubstituted monovalent hydrocarbon radical which is not aliphatically unsaturated, and each molecule has on average at least three such hydrogen atoms bonded to silicon atoms,
c, d, independently of one another, are positive numbers,
with the proviso that 1≦c<3, 0<d≦1 and 1<c+d≦3,
and
a hydrosilylation catalyst containing at least one transition metal.

4. The silicone rubber composition of claim 3, wherein at least one hydrosilylation catalyst is selected from the group consisting of compounds of the formula (5) 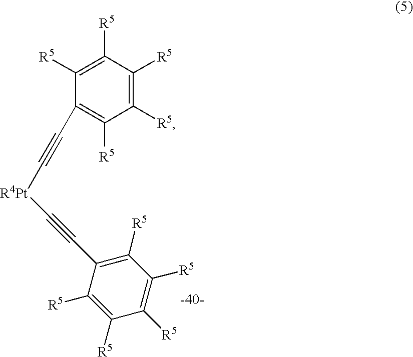
oligomeric or polymeric compounds which are composed of structural units of the general formula (6) 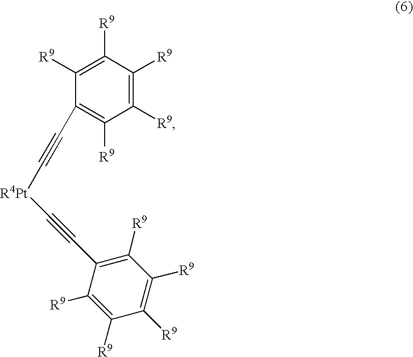
and optionally structural units of the general formula (7)
R¹¹ᵣSiO_{(4-4)/2} (7)
in which
R⁴ is an optionally substituted diene which is linked to platinum by at least one π-bond and is a straight or a branched chain having 4 to 18 carbon atoms or a cyclic ring having 6 to 28 carbon atoms,
R⁵ are identical or different and are a hydrogen atom, a halogen atom, —SiR⁶₃, —OR⁸ or monovalent, optionally substituted hydrocarbon radicals having 1 to 24 carbon atoms, with the proviso that, in the compounds of the formula (5), at least one radical R⁵ is —SiR⁶₃,
R⁶ are identical or different and are hydrogen, a halogen atom, —OR⁸ or monovalent, optionally substituted hydrocarbon radical having 1 to 24 carbon atoms,
R⁸ are identical or different and are a hydrogen atom, —SiR⁶₃ or a monovalent optionally substituted hydrocarbon radical having 1 to 20 carbon atoms,
R⁹ are identical or different and are a hydrogen atom, a halogen atom, —SiR⁶₃, —SiR⁶₍₃₋ₜ₎[R¹⁰SiR¹¹ₛO_{(3-s)/2}]ₜ, —OR⁸ or monovalent, optionally substituted hydrocarbon radicals having 1 to 24 carbon atoms, with the proviso that, in formula (6), at least one radical R⁹ is
—SiR⁶₍₃₋ₜ₎[R¹⁰SiR¹¹ₛO_{(3-s)/2}]ₜ,
R¹⁰ are identical or different and are an oxygen or a divalent, optionally substituted hydrocarbon radicals having 1 to 24 carbon atoms, optionally bonded to the silicon via an oxygen atom,
R¹¹ are identical or different and are hydrogen or an organic radical,
r is 0, 1, 2 or 3,
s is 0, 1, 2 or 3, and
t is 1, 2 or 3.

5. The silicone rubber composition of claim 4, wherein at least one hydrosilylation catalyst is selected from the group consisting of bis(alkynyl)(1,5-cyclooctadiene)platinum, bis(alkynyl)(bicyclo[2.2.1]hepta-2,5-diene)platinum, bis(alkynyl)(1,5-dimethyl-1,5-cyclooctadiene)platinum and bis(alkynyl)(1,6-dimethyl-1,5-cyclooctadiene)platinum complexes.

6. The silicone rubber composition of claim 1, wherein the component (B) is surface-treated with silicon compounds or hydroxyl-terminated diorganosiloxane oligomers, the proportion of these silicon compounds or hydroxyl-terminated diorganosiloxane oligomers which contain unsaturated groups being at least 10%

7. The silicone rubber composition of claim 3, wherein the silicone rubber composition additionally contains an inhibitor.

8. The silicone rubber composition of claim 1, wherein the silicone rubber composition additionally contains one or more metal oxides other than components (B) and (C).

9. The silicone rubber composition of claim 1, wherein the silicone rubber composition additionally contains a platinum compound or a platinum complex, or the reaction product of a platinum compound or a platinum complex with an organosilicon compound which has basic nitrogen bonded to the silicon via carbon.

10. The silicone rubber composition of claim 9, wherein the organosilicon compound which has basic nitrogen bonded to the silicon via carbon is selected from the group consisting of N-(2-aminoethyl)-3-aminopropyltrimethoxysilane, N-(2-aminoethyl)-3-aminopropyltriethoxysilane, 3-aminopropyltrimethoxysilane, and 3-aminopropyltriethoxysilane.

11. The silicone rubber composition of claim 9, wherein the composition has a nitrogen content in the range from 15 ppm to 500 ppm.

12. The silicone rubber composition of claim 1, wherein the silicone rubber composition contains further fillers.

13. A process for the preparation of a silicone rubber composition of claim 1, wherein the composition is prepared by mixing the composition components in a mixing unit.

14. The process of claim 13, wherein the components (A), (B) and (C), and optionally (E), (F) and (G) are mixed in a kneader, optionally with supply of heat, and the precursor thus obtained is completed with the addition of component (D) on a roll mill.

15. A high-voltage insulator or flame-retardant cable sheath comprising the silicone rubber composition of claim 1.

16. A silicone rubber obtained by crosslinking the silicone rubber composition of claim 1.
